(19) United States
(12) Patent Application Publication
(10) Pub. No.: US 2008/0114641 A1
(43) Pub. Date: May 15, 2008

(54) Process and apparatus for marketing data collection and analysis aggregation of funds

(76) Inventor: Christopher Keenum, Atlanta, GA (US)

Correspondence Address: Kristin C. Castle, Esq., 96 Oakmont Ave, Piedmont, CA, 94610, US

(21) Appl. No.: 11/600,586

(22) Filed: Nov. 15, 2006

(51) Int. Cl. G06F 17/30; G06Q 40/00

(52) U.S. Cl. 705/10; 705/35

(57) ABSTRACT

The present invention comprises methods and an apparatus for the marketing data collection and analysis and the aggregation of funds from advertisers. The techniques include receiving data from a Web site that has a marketing program uploaded from a provider server, for data collection, analysis and the aggregation of funds, including the machine implemented steps of providing one or more Web sites displaying a series of commercials in sequence, wherein a user logs on to the Web site; providing a problem having an answer combined with a commercial in the sequence, wherein if a correct answer to the problem is provided be the user, the commercial sequence proceeds and funds are collected for each commercial played in the sequence until and/or unless an incorrect or no answer is provided; displaying an error page that replays the commercial at the point in the sequence where the user chose the incorrect answer until and/or if the answer is chosen; ending the program if the answer is never chosen; and continuing through the commercials in the sequence if the correct answer is continuously chosen and collecting funds until the user completes the sequence.

### FIELD

The present invention generally relates to internet marketing and advertising. More specifically, the invention relates to automated monetary contribution collection, data collection and analysis.

### BACKGROUND

The approaches described in this section could be pursued, but are not necessarily approaches that have been previously conceived or pursued. Therefore, unless otherwise indicated herein, the approaches described in this section are not prior art by inclusion to the claims in this application and are not admitted prior art by the inclusion in this section.

With improving technologies in telephone communication, television broadcasting, and the Internet marketplace, many new advertising strategies are created on the foundation of previous concepts. Take the example of the Internet. Search engine companies were able reapply the previous of concept of billboard-advertisements to the new Internet media. Now, millions of people view banner ads that are displayed like billboards across Web pages worldwide.

Marketing trends will continue to be dictated by advancements in technology. The difficulty in internet marketing and advertising arises from competition with traditional fundraising methods. At an internet Web site, for example, a charitable Web site such as www.thebreastcancersite.com, a user clicks a button to generate a donation for charities. A banner is displayed on the Web site that states “click to make a donation.” The money for the donation comes each time a user clicks the button. Typically, a small amount of 2 to 4 cents is generated per view.

These sites are called in the business “click-to-donate sites” and are designed to benefit both the selected charity and also the advertising company. This online campaign is able to target a very valuable and specific demographic while donations are raised for a reputable charity. Through this method of online advertising, a company now has an opportunity to reach a unique online audience while certainly improving their general image.

However, herein the difficulties lie. The lack of consumer viewing combined with insufficient advertising have diminished the potential of these “click-to-donate” Web sites to produce any meaningful income or marketing. Without high viewer traffic, sponsors are unlikely to commit large advertising dollars. Additionally, without substantial donations from advertisers, sponsors are unlikely to log on and contribute. The diminutive scale and insufficient technology have made the “click-to-donate” sites insignificant.

### BRIEF DESCRIPTION OF THE DRAWINGS

FIG. 1 is a block diagram that depicts an example system for automated data collection and analysis according to one embodiment of the invention.

FIG. 2 is a flowchart that depicts a process for automated data collection and analysis according to the invention.

FIG. 3 is a block diagram that illustrates a computer system upon which an embodiment of the invention may be implemented.

### DETAILED DESCRIPTION

A method and apparatus for automated data collection and analysis is described. In the following description, for the purposes of explanation, numerous specific details are set forth in order to provide a thorough understanding of the present invention. It will be apparent, however, to one skilled in the art, that the present invention may be practiced without these specific details. In other instances, well-known structures and devices are shown in block diagram form in order to avoid unnecessarily obscuring the present invention.

Embodiments are described herein according to the following outline:

1.0 General Overview

2.0 Definitions

3.0 Functional Overview

4.0 Hardware Overview

5.0 Extensions and Alternatives

### 1.0 GENERAL OVERVIEW

The needs identified in the foregoing Background, and other needs and objects that will become apparent from the following description, are achieved in the present invention, which includes, in one aspect, techniques for automated data collection and analysis with regard to marketing data and aggregation of funds, including, but not limited to, receiving a request from a user to access an internet Web site, tracking the user's internet protocol address and storing user's information in the provider data base, wherein the analysis results are based on user session variables, etc.

In this aspect, the techniques include receiving data from a Web site that has a marketing program uploaded from a provider server, for data collection, analysis and the aggregation of funds, including the machine implemented steps of providing one or more Web sites displaying a series of commercials in sequence, wherein a user logs on to the Web site; providing a problem having an answer combined with a commercial in the sequence, wherein if a correct answer to the problem is provided be the user, the commercial sequence proceeds and funds are collected for each commercial played in the sequence until and/or unless an incorrect or no answer is provided; displaying an error page that replays the commercial at the point in the sequence where the user chose the incorrect answer until and/or if the answer is chosen; ending the program if the answer is never chosen; and continuing through the commercials in the sequence if the correct answer is continuously chosen and collecting funds until the user completes the sequence.

In a related aspect, a command set comprises one or more commands to collect data from two or more devices simultaneously. An additional aspect includes receiving a request from a user to access an internet Web site, tracking the user's internet protocol address and storing user's information in the provider data base, wherein the analysis results are based on user session variables.

In a related feature, the problem comprises an image verification box that may or may not coincide with a commercial in the sequence, wherein if the correct image is typed into the user computer, the commercial sequence proceeds and funds are collected for each commercial played.

In a related feature, the problem comprises an audio verification file that may or may not coincide with a commercial in the sequence, wherein if the correct message is typed into the user computer, the commercial sequence proceeds and funds are collected for each commercial played.

In a related feature, the problem comprises a plurality of commercials in the sequence playing simultaneously along with a list of names of advertisers and in order to move to the next commercial sequence the users must match the names of the advertisers with the commercials, if the correct match is made, the funds are collected for each commercial viewed in the sequence and the commercial sequence proceeds until and/or unless an incorrect or no match is chosen.

In a related feature, the problem comprises a plurality of source identifiers that coincide with a commercial in the sequence, wherein if the correct source identifier is chosen by the user, the commercial sequence proceeds and funds are collected for each commercial played in the sequence.

Additionally, one or more error pages may be displayed until and/or if the answer is not chosen, wherein funds continue to be collected if the correct image is chosen.

In a related aspect, techniques for data collection, analysis and the aggregation of funds, including the machine implemented steps of receiving data from a Web site having a marketing program uploaded from a provider server; providing one or more Web sites displaying a series of commercials in sequence, wherein a user logs on to the Web site; providing a plurality of source identifiers that coincide with a commercial in the sequence, wherein if the correct source identifier is chosen by the user, the commercial sequence proceeds and funds are collected for each commercial played in the sequence until and/or unless an incorrect or no source identifier is chosen; displaying an error page that replays the commercial at the point in the sequence where the user chose the incorrect source identifier until and/or if the correct source identifier is chosen; ending the program if the source identifier is never chosen; and continuing through the commercials in the sequence if the correct source identifier is continuously chosen and collecting funds until the user completes the sequence.

In another aspect, a machine-readable is provided for carrying one or more sequences of instructions for automated data collection and analysis, which instructions, when executed by one or more processors, cause the one or more processors to carry out the techniques described herein.

In another aspect, an apparatus for marketing data collection, analysis and the aggregation of advertising funds, including means for carrying out the techniques described herein.

In another aspect, an apparatus for marketing data collection, analysis and the aggregation of advertising funds, including a network interface that is coupled to the data network for receiving from which one or more packet flows therefrom; a processor; one or more stored sequences of instructions which, when executed by the processor, cause the processor to carry out the steps described herein,

In another aspect, an apparatus includes techniques for data collection, analysis and the aggregation of funds, including a means for receiving data from one or more Web sites having a marketing program uploaded from a provider server, wherein receiving the data includes: providing one or more Web sites displaying a series of commercials in sequence, wherein a user logs on to the Web site; providing a plurality of source identifiers that coincide with a commercial in the sequence, wherein if the correct source identifier is chosen by the user the commercial sequence proceeds and funds are collected for each commercial played in the sequence until and/or unless an incorrect or no source identifier is chosen; displaying an error page that replays the commercial at the point in the sequence where the user chose the incorrect source identifier until and/or if the correct source identifier is chosen; ending the program if the source identifier is never chosen; and continuing through the commercials in the sequence if the correct source identifier is continuously chosen and collecting funds until the user completes the sequence.

### 2.0 DEFINITIONS

The “Internet” is defined is a worldwide system of computer networks—a network of networks in which users at any one computer can, if they have permission, get information from any other computer (and sometimes talk directly to users at other computers). It was conceived by the Advanced Research Projects Agency (ARPA) of the U.S. government in 1969 and was first known as the ARPANET. The original aim was to create a network that would allow users of a research computer at one university to be able to “talk to” research computers at other universities. A side benefit of ARPANet's design was that, because messages could be routed or rerouted in more than one direction, the network could continue to function even if parts of it were destroyed in the event of a military attack or other disaster.

Today, the Internet is a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called TCP/IP (for Transmission Control Protocol/Internet Protocol). Two recent adaptations of Internet technology, the intranet and the extranet, also make use of the TCP/IP protocol.

An “Internet Service Provider” is defined as a An ISP (Internet service provider) is a company that provides individuals and other companies access to the Internet and other related services such as Web site building and virtual hosting. An ISP has the equipment and the telecommunication line access required to have a point-of-presence on the Internet for the geographic area served. The larger ISPs have their own high-speed leased lines so that they are less dependent on the telecommunication providers and can provide better service to their customers. Among the largest national and regional ISPs are AT&T WorldNet, IBM Global Network, MCI, Netcom, UUNet, and PSINet.

A Web browser is a software application that enables a user to display and interact with text, images, and other information typically located on a Web page at a Web site on the World Wide Web or a local area network. Text and images on a Web page can contain hyperlinks to other Web pages at the same or different Web sites. Web browsers allow a user to quickly and easily access information provided on many Web pages at many Web sites by traversing these links.

A “Web browser” is a software application that enables a user to display and interact with text, images, and other information typically located on a Web page at a Web site on the World Wide Web or a local area network. Text and images on a Web page can contain hyperlinks to other Web pages at the same or different Web sites. Web browsers allow a user to quickly and easily access information provided on many Web pages at many Web sites by traversing these links.

Web browsers available for personal computers include Microsoft Internet Explorer, Mozilla Firefox, Apple Safari, Netscape, and Opera, etc. Web browsers are the most commonly used type of HTTP user agent. Although browsers are typically used to access the World Wide Web, they can also be used to access information provided by web servers in private networks or content in file systems.

A “Uniform resource locator” (URL) is defined as a URL or a URI which, “in addition to identifying a resource, [provides] a means of locating the resource by describing its primary access mechanism (e.g., its network ‘location’).

“Internet Protocol” is defined as an IP address which is a numeric address that is used to identify a network interface on a specific network or subnetwork. Every computer or server on the Internet has an IP address. It is a unique number consisting of four parts separated by dots. For example, 198.204.112.1. The address contains two pieces of information: the network portion, known as the IP network address, and the local portion, known as the local or host address.

“Open Source Software” is defined as software for which the underlying programming code is available to the users so that they may read it, make changes to it, and build new versions of the software incorporating their changes. There are many types of Open Source Software, mainly differing in the licensing term under which (altered) copies of the source code may (or must be) redistributed.

“Hypertext Markup Language” is defined as the basic language used to write Web pages. HTML is a mark up language and not a full-blown programming language so is therefore essentially static in nature. HTML is parsed by your Web browser when a Web page downloads and consists of tags (commands to tell the browser how to render the text, where to load in graphics etc on the Web page) as well as the actual text. It is a subset of Standard Generalized Markup Language (SGML), this language provides codes used to format hypertext documents. Individual codes are used to define the hierarchy and nature of various components of a document, as well as to specify hyperlinks.

A “MySQL database” is defined as MySQL is a multithreaded, multi-user, SQL Database Management System (DBMS) with more than six million installations. MySQL AB makes MySQL Server available as free software under the GNU General Public License (GPL), but they also offer the MySQL Enterprise subscription offering for business users and dual-license it under traditional proprietary licensing arrangements for cases where the intended use is incompatible with the GPL.

An “Application Programming Interface” (API), the interface (calling conventions) by which an application program accesses operating system and other services, is defined at source code level and provides a level of abstraction between the application and the kernel (or other privileged utilities) to ensure the portability of the code. There are APIs available that allow applications written in numerous programming languages to access MySQL databases, including: C, C++, C#, Borland Delphi (via dbExpress), Eiffel, Smalltalk, Java (with a native Java driver implementation), Lisp, Perl, PHP, Python, Ruby, REALbasic (Mac), FreeBasic, and Tcl; each of these uses a specific API. An ODBC interface called MyODBC allows additional programming languages that support the ODBC interface to communicate with a MySQL database, such as ASP or Coldfusion. MySQL is mostly implemented in ANSI C.

MySQL is popular for Web applications such as MediaWiki or Drupal and acts as the database component of the LAMP, MAMP and WAMP platforms (Linux/Mac/Windows-Apache-MySQL-PHP/Perl/Python), and for open-source bug tracking tools like Bugzilla.

To administer MySQL databases one can use the included command-line tool (commands: mysql and mysqladmin). Also downloadable from the MySQL site are GUI administration tools: MySQL Administrator and MySQL Query Browser. Both of the GUI tools are now included in one package called MySQL GUI Tools. A widespread and popular alternative, written in PHP, is the free software Web application phpMyAdmin.

A “Hypertext Preprocessor” (PHP) is defined as an open source server side programming language extensively used for Web scripts and to process data passed via the Common Gateway Interface from HTML forms etc. PHP can be written as scripts that reside on the server and may produce HTML output that downloads to the Web browser. Alternatively, PHP can be embedded within HTML pages that are then saved with a .php file extension. The PHP sections of the page are then parsed by the PHP engine on the server and the PHP code stripped out before the page is downloaded to the Web browser.

A “Query” is defined as a word, phrase or group of words characterizing the information a user seeks from search engines and directories. The search engine subsequently locates Web pages to match the query.

An “Array” is defined in computer programming, as a vector or list, is one of the simplest data structures. Arrays hold equally-sized data elements, generally of the same data type. Individual elements are accessed by index using a consecutive range of integers, as opposed to an associative array. Some arrays are multi-dimensional, meaning they are indexed by a fixed number of integers, for example by a tuple of four integers. Generally, one- and two-dimensional arrays are the most common.

A “Scalar” is defined in computing, as a variable or field that can hold only one value at a time; as opposed to composite variables like array, list, record, etc. In some contexts, a scalar value may be understood to be numeric. A scalar data type is the type of a scalar variable. For example, char, int, float, and double are the most common scalar data types in the C programming language.

The term “machine-readable medium” as used herein refers to any medium that participates in providing data that causes a machine to operation in a specific fashion.

“Javascript” is defined as a type of Scripting language (originally called LiveScript) developed by Netscape Communications for use with the Navigator browser. JavaScript code forms part of the HTML page and can be used for example to respond to user actions such as button clicks or to run processes locally or validate data.

A “Hit” is defined as a term used to describe the volume of traffic a Web site is receiving. Specifically, a “hit” means a single request from a Web browser for a single item from a Web page. A Web surfer visiting a single Web page with 3 graphics would cause 4 hits to be recorded, one for the page and 3 for the graphics. The term is often used as a rough measurement of traffic to a page or site but can be very misleading in determining unique visitors to a Web site.

A “session variable” is defined in programming languages, a language object that may take different values, one at a time during a session.

“Cost per thousand” advertising is the most common basis in the business and is used for most display advertising and rich media. This scheme most closely resembles offline advertising, wherein the advertiser is paying for exposure of their message to a specific audience. CPM costs are priced per thousand.

Cost Per Click (CPC) advertising is also defined as performance based advertising. It is common in search marketing, where it is often known as Pay per click (PPC). In this scheme, an advertisement may be displayed (and assumedly viewed) many times, but the advertiser pays based only on the number of user clicks. This system provides an incentive for publishers to target ads correctly (often by keyword), as the payment depends not upon the ad being seen but upon the viewer's responding and following the hyperlink.

Cost Per Action (CPA) or (Cost Per Acquisition) advertising is performance based and is common in the affiliate marketing sector of the business. In this payment scheme, the publisher takes all the risk of running the ad, and the advertiser pays for the media on the basis of only the number of users who complete a transaction, such as a purchase or sign-up. This is the best type of rate to pay for banner advertisements and the worst type of rate to charge. Similarly, Cost Per Lead (CPL) advertising is identical to CPA advertising and is based on the user completing a form, registering for a newsletter or some other action that the merchant feels will lead to a sale. Also common, Cost Per Order (CPO) advertising is based on each time an order is transacted.

A “Landing page” is defined as a page that users click through to from an advertisement. For best results, these pages are highly targeted for the reader and specific to the ad. Landing pages are used for advertisers who either do not have a Web site or who wish to provide a special offer or email form which does not exist on their Web site. This is the page visitors find themselves after clicking on a PPC or CPC advertisement. In order to maximize the conversion rate it is crucial to have a well thought out and well developed landing page.

A “Home Page” is defined as the page designated as the main point of entry of a Web site (or main page) or the starting point when a browser first connects to the Internet. Typically, it welcomes you and introduces the purpose of the site, or the organization sponsoring it, and then provides links to the lower-level pages of the site. In business terms, it's the grabber.

A “Wireless Network” allows computers to share printers, files or an internet connection without any wires between them. Wireless networking hardware uses radio frequencies to transmit information between the individual computers; each computer requires a wireless network adapter. A wireless network hub or router is used to bridge the wireless network to traditional ethernet or home phone line networks, or provide a shared internet connection.

“Dial-up Access” is an inexpensive but relatively slow form of internet access in which the client uses a modem to dial the internet service provider's node, a dialup server type such as the PPP and TCP/IP protocols to establish a modem-to-modem link, which is then routed to the internet. It is now legacy technology in the advent of widely available broadband internet access in the Western World.

A “LAN” or a “local area network” is a computer network limited to the immediate area, usually the same building or floor of a building. LANs are capable of transmitting data at very fast rates, much faster than the data that is transmitted to you over the Internet; there is no limit on the number of computers that can be attached to a single LAN.

A “WAN” or a “wide area network” is a geographically dispersed telecommunications network. The term distinguishes a broader telecommunication structure from a local area network. A wide area network may be privately owned or rented, but the term usually connotes the inclusion of public (shared user) networks. An intermediate form of network in terms of geography is a metropolitan area network (MAN).

“Client” is defined as the requesting program or user in a client/server relationship. For example, the user of a Web browser is effectively making client requests for pages from servers all over the Web. The browser itself is a client in its relationship with the computer that is getting and returning the requested HTML file. The computer handling the request and sending back the HTML file is a server.

“Users” are defined as people using or accessing the World Wide Web. Could also refer to people accessing a specific Web site or Web page, in this case the user is the same as a visitor or customer.

An “Advertiser” is defined as any Web site that sells a product or service, accepts payments, and fulfills orders. An advertiser places ads and links to its products and services on other Web sites (publishers) and pays those publishers a commission for leads or sales that result from their sites.

A “Marketeer” or “marketer” is someone whose job it is to present a good or service to the market place in an attractive way so that others will be tempted to buy it. This may include advertising the product but also may include addressing its image in a more general way. The term Marketeer is increasing applicable to a niche group of specialist on the internet that leverage New Media to communicate product value.

“Sequence” is defined as a structured collection of video, audio, and graphics clips, edit information, and effects.

A “Commercial” is defined as An audio or video advertising announcement, usually presented on television, radio or in a movie theater.

A “Problem” as it applies to the invention is anything that the user has to interact with, not necessarily related to the advertisement. For example, it could be a series of buttons having source identifiers on them, one of which identifies the commercial. It could also be an addition problem, a tic-tac-toe game, or some other puzzle or problem where one or more steps answered correctly indicate that the user was at the computer viewing the commercials.

“Combined” as used in the present invention means that a problem (as defined above) and a commercial in a sequence are linked together. The problem is not necessarily related to the advertisement. In order to move forward in the sequence, a user must solve the problem or answer the question.

“Joint Photographic Experts Group” is a compression technique used for saving images and photographs. This compression method reduced the file size of the images without reducing its quality. A standardized image compression mechanism designed for compressing either full-color or grayscale photographic images, often for use on the Web. JPG is “lossy,” meaning that the decompressed image is not quite of the same quality as the original image. The most common file extensions for this format are .jpeg, .jfif, .jpg, .JPG, or .JPE “bitmap” is defined as the standard graphics file format on Windows-compatible computers. Bitmap graphics support 24-bit color and can be saved for Windows or OS/2 systems. FrontPage can import BMP files. The file extension for bitmap is .bmp

“Graphic Interchange Format” is defined as a common format for image files, especially suitable for images containing large areas of the same color. GIF format files of simple images store photographic images as well as JPEG. GIFs typically display in 256 colors and have built-in compression. Static or animated GIF images are the most common form of banner creative. The file extension for bitmap is .gif

A “Shockwave Flash file” (SWF) is a proprietary vector graphics file format produced by the Adobe Flash software. Intended to be small enough for publication on the Web, SWF files can contain animations or applets of varying degrees of interactivity and function. The Flash program produces SWF as the compressed and uneditable final product, whereas it uses the .fla format for its editable working files. Flash is currently the most ubiquitous and dominant format for displaying animated vector graphics on the Web, far exceeding the open standard SVG format, which has met with problems over competing implementations of the W3C standard. SWF is also sometimes used for creating animated display graphics and menus for DVD movies, and television commercials. The file extension for Shockwave Flash file is .swf “World Wide Web Consortium” (W3C) is an international consortium of companies involved with the Internet and the Web. The W3C was founded in 1994 by Tim Berners-Lee, the original architect of the World Wide Web. The organization's purpose is to develop open standards so that the Web evolves in a single direction rather than being splintered among competing factions. The W3C is the chief standards body for HTTP and HTML.

“QuickTime” (MOV) is a multimedia framework developed by Apple Computer, capable of handling various formats of digital video, media clips, sound, text, animation, music, and several types of interactive panoramic images. To view a file with the .mov extension, you need QuickTime multimedia technology to run it. MOV files can be movie clips, such as Video for Windows' AVI files, or still images, such as GIFs. The file extension for QuickTime is .mov.

“Moving Picture Expert Group”, .mpg is the file extension that denotes a file that is in MPEG digital video format.

“MP3” stands for ‘MPEG-2 Layer 3’, which is a compression standard developed by the Moving Picture Experts Group. The most popular CODEC (for compressor-decompressor) software that shrinks music into digital files small enough for transmission over the Internet. The MP3 format strips away layers of inaudible sounds, compresses what is left, then decompresses those same files for listening on a computer or audio player. MP3 is “open source” software, in the public domain and freely available on the Internet. The file extension for ‘MPEG-2 Layer 3’ is .mp3

### 3.0 STRUCTURAL OVERVIEW

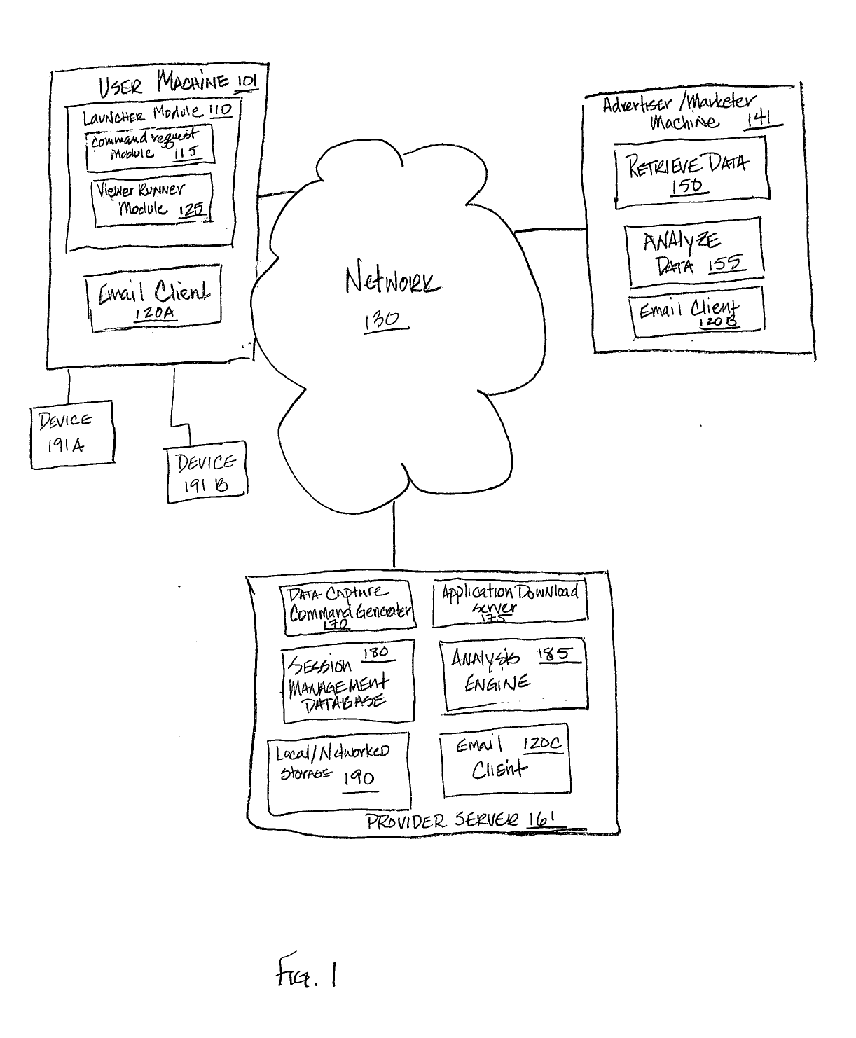

FIG. 1 is a block diagram that depicts an example system for automated data collection and market analysis according to one embodiment of the invention.

User machine 101 is communicatively coupled to network 130 and devices 191A and 191B. Marketer/Advertiser machine 141 and provider server 161 are also communicatively coupled to network 130 and to one another. In various embodiments, the network 130 is a wireless network, a dial-up access, the internet, a LAN, a WAN or any other communications network known now or developed in the future.

User machine 101, marketer/advertiser machine 141, devices 191A and 191B and provider server 161 are each logical machines. Each logical machine can run on separate physical computing machines or can be running on the same physical computing machine as one or more of the other logical machines. Various embodiments of computers and other machines are described in detail below in the section entitled Hardware Overview. In various embodiments, devices 191A and 191B are routers, switches, hubs, and any other appropriate routing devices.

User machine 101 comprises a launcher module 110 and an email client module 120A. In one embodiment, the launcher module 110 is one or more software elements running on the user machine 101. In various embodiments, the launcher module 110 is written in PHP, Java, Perl, C++, FORTRAN, Pascal, or any other appropriate language. In various embodiments, In various embodiments, command runner module 115 is a Hyper Text Markup Language application that can execute HTML files, an application that started by executing an HTML file, an open source command running mechanism, or any other appropriate mechanism. In various embodiments, the launcher module 110 is Java Web Start™, an application that can execute Java Network Launching Protocol™ (“JNLP”) files, a proprietary launcher application, or any other appropriate launcher mechanism. In various embodiments, the launcher module 110 can execute sets of commands including data capture commands, send and receive commands using appropriate communication mechanisms, or commands to make the launcher module 110 pause for a predefined period of time.

In one embodiment, launcher module 110 comprises command runner module 115. In various related embodiments, command runner module 115 is a program running on user machine 101 as part of launcher module 110 or separately from launcher module 110. In various embodiments, command runner module 115 is written in Java, Perl, C++, FORTRAN, Pascal, or any other appropriate language. In various embodiments, In various embodiments, command runner module 115 is a Hyper Text Markup Language application that can execute HTML files, an application that started by executing an HTML file, an open source command running mechanism, or any other appropriate mechanism. In various embodiments command runner module 115 is a Java Web Start™ application, an application that can execute JNLP files, an application that started by executing a JNLP file, a proprietary command running application, or any other appropriate command running mechanism. In various embodiments, command runner module 115 executes sets of commands including data capture commands, send and receive commands using appropriate communication mechanisms, or commands to make command runner module 115 pause for a predefined period of time.

In one embodiment, launcher module comprises viewer runner module 125. In various related embodiments, viewer runner module 125 is a program running on user machine 101 as part of launcher module 110 or separately from launcher module 110. In various embodiments, viewer runner module 125 is written in PHP, Java, Perl, C++, FORTRAN, Pascal, or any other appropriate language. Viewer runner module 125 allows for commercials to be viewed by the users. For example, each commercial page may be in, including but not limited to, an HTML format. The commercials, once playing, can be in any format including, but not limited to, .jpg, .bmp, .gif, .swf, .mov .mpg, .mp3, etc.

In one embodiment, the email client modules 120A, 120B are programs that can send and receive email using appropriate communication means. In various embodiments, the email client modules 120A, 120B are programs that can render email documents written as unformatted text or in a structured format such as hypertext markup language (HTML), extensible markup language (XML), portable document format (PDF), or postscript (PS).

The Marketer/Advertiser machine 141 may comprise retrieve data module 150, analysis data module and email client module 120B. Various embodiments of email client module 120B are described above. In various embodiments, data capture command generator module 155 is a program running on the Marketer/Advertiser machine 141, a program running on a machine communicatively coupled to Marketer/Advertiser machine 141, or a module running as part of a program which is running either on Marketer/Advertiser machine 141 or a machine thereto communicatively coupled. In various embodiments, analysis data module 155 is a program running on Marketer/Advertiser machine 141, a program running on a machine communicatively coupled to Marketer/Advertiser machine 141, or a module running as part of a program which is running either on Marketer/Advertiser machine 141 or a machine thereto communicatively coupled. As is known to one of ordinary skill in the art, the invention is directed to method and apparatus of marketing and advertising, the marketer/advertiser machine may be designed to be specifically tailored for the needs of the marketer/advertiser and set forth for exemplary purposes only.

Provider server 161 comprises data capture command generator 170, application download server 175, session management database 180, an analysis engine module 185, local/network storage module 190 and email client module 120C. Various embodiments of email client module 120B are described above.

In various embodiments, data capture command generator module 170 is a program running on provider server 161, a program running on a machine communicatively coupled to provider server 161, or a module running as part of a program which is running either on provider server 161 or a machine thereto communicatively coupled.

In various embodiments, application download server module 175 is a program running on the provider server 161, a program running on a machine communicatively coupled to the provider server 161, or a subroutine running in a program which is running on the provider server 161 or a machine thereto communicatively coupled. In various embodiments, application download server module 175 includes a file transfer protocol (FTP) server, a hypertext transfer protocol (HTTP) server, a secure HTTP (HTTPS) server, a TCP/IP socket, or any other appropriate communication mechanism.

In various embodiments, session management database server 180 is a program running on a machine communicatively coupled to the provider server 161, or a subroutine running in a program which is running on the provider server 161 or a machine thereto communicatively coupled. In various embodiments, session management database includes data management system. In various embodiments, session management database server 180 includes an open source database system including, but not limited to, MySQL database server, PostgreSQL, FireBird, MaxDB (SAP DB), Ingres, Derby, HSQLDB, Backplane, eXsit, or an any other appropriate database server, open source or a proprietary database server system including but not limited to ORACLES and MICROSOFT®. In various embodiments, preferably a My SQL database server, session management database server 180 includes one or a plurality of server modules, database nodes and one or more management server modules which handle the system configuration and are used to change the configuration of the system.

In various embodiments, analysis engine module 185 is a program running on provider server 161, a program running on a machine communicatively coupled to provider server 161, or a module running in a program which is running on provider server 161 or a machine thereto communicatively coupled. In various embodiments, analysis engine module 185 is an expert system, a rule-based engine, a rule-based markup language (RBML) engine, or any other appropriate analysis engine.

In various embodiments, local/networked storage module 190 is a program running on provider server 161, a program running on a machine communicatively coupled to provider server 161, or a module running in a program which is running on provider server 161 or a machine thereto communicatively coupled. In various embodiments, local/networked storage module 190 is a module communicatively coupled to provider server 161 and communicatively coupled to network 130. Local/networked storage module 190 provides complex data storage for complex session data and provides an additional storage medium to back-up session management database server 180. Local/networked storage module 190 is able to create tables to hold information regarding information about the sessions of each user in the following areas: variables—the name of the variable and it's value, for example, an idle sessions timeout variable is second; users—store a user's email, name password, last login and access times; sessions—store cookie, user id, session start, and access times.

### 3.0 FUNCTIONAL OVERVIEW

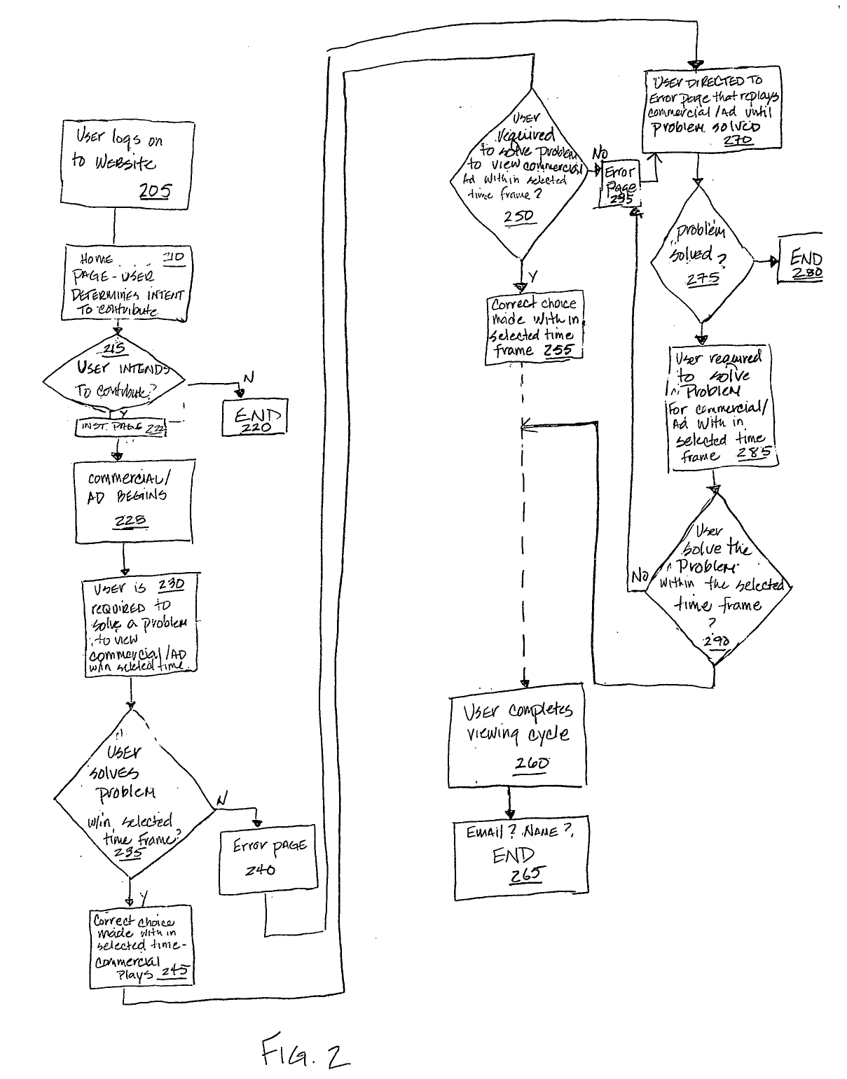

FIG. 2 is a flowchart that depicts a process for automated data collection and analysis according to one embodiment of the invention.

First a user logs on to a Web site in step 205. For example, in the context of FIG. 1, an individual associated with user machine 101, such as any individual who uses the Internet, logs on to, for example purposes only a charitable Web site using the current inventive process.

At step 210 the user arrives at home page/index.html. In various embodiments, a user's IP address is called using PHP, Perl, Python, and Ruby, Java, C++, FORTRAN, Pascal, or any other appropriate language. In various embodiments, the address is then stored in, for exemplary purposes only, in a MySQL database or any other appropriate associated session database system 180 shown in FIG. 1. A general hit system is in place in the session database system shown in FIG. 1. A query within the session database would be made to determine if the user has already visited the Web page or seen the commercial series. If the IP address had been entered previously, then that IP's row of the database is merely updated. If the IP address had not been entered previously, the update would tick up one. The column “hits” would refer to the number of times a user had hit the home page/index.html.

In various embodiments, a general out of the box hit system could be used that determines where the IP originates geographically, determines how may hits per hour and peak times users are visiting the specified page.

In various embodiments, home page/index.html 210, a portion of which includes a detailed description of what the user is contributing to and the benefit to the user, instructs the user on how to begin the commercial series. In various embodiments, a home page may be synonymous with a landing page having an index.php, index.htm, index.cfm, index.asp, etc. In various embodiments, a portion of home page/index.html 210 includes a section for the user to enter his or her email for future opportunities to contribute.

A step 204, a user determines his or her intent to contribute. If the user decides not to continue, the user quits and the program ends at step 220. If the user decides to continue, a Web session is started when the user clicks the “start here” button” on home page/index.html 210. A session is started using PHP, Perl, Python, and Ruby, Java, C++, FORTRAN, Pascal, or any other appropriate language in the Web Browser. Session variables are specified referring to the user's IP address. In addition, session management database 180 is queried to determine when and if the user had last visited the Web site and followed the entire commercial sequence (this will be explained in detail below). As set forth above and as one of ordinary skill in the art would appreciate, this can be accomplished through many languages and database types.

At step 222, instructions.html is opened, the user is directed to watch the commercial and directed to solve a problem, such as, for example, identify the source identifier out of a plurality of buttons of a plurality of source identifiers, one of which identifies the commercial they are watching, or solve a puzzle or solve a problem. Anything that commits the user to viewing the commercial. A note is made in the session variable and the session management database 180 that that the visitor had visited the instructions.html. The user then clicks the “Begin Ads” button to begin the commercial ads at step 222. At step 225, commercial page one/1.html opens and the commercial begins. A note is made in the session variable and the session management database 180 that that the visitor had visited the commercial page/1.html. Each time a user with a unique IP watches a new commercial, PHP or any other appropriate language is used to access session management database 180. Session management database 180 keeps track of which commercials have been seen by whom and at what time. In various embodiments, the variables are being stored in an array or a scalar.

At step 230, the user is required to solve the problem, as instructed at the instructions page, within a selected time period. For exemplary purposes only, if using a plurality of source identifiers, in certain embodiments, the multiple choice box is an HTML form with approximately four to five multiple choice buttons for each company. The buttons will be randomized to hamper automated scripts. After a selected time lapses, in certain embodiments, JavaScript will be used to redirect the user to the appropriate page based on whether they clicked the correct source identifier.

The selected time period can be from 0 to 1 minute. If the user does not select the correct source identifier or does not select any source identifier at all at step 235, the user is directed to an error page/1a.html 240.

If the user selects the correct source identifier within the selected time, the commercial completes at step 245. The commercial can be in any format compatible with the application, bandwidth and download time, including but not limited to flash, jpg, links, words or any other appropriate format. After a selected time lapses, in certain embodiments, JavaScript will be used to redirect the user to the next commercial page/2.html when the clicked the correct source identifier at step 250. Again the user must click on the correct source identifier within a selected time period.

If the user does not select the correct source identifier or does not select any source identifier at all at step 235, the user is directed to an error page/1a.html 295.

If the user selects the correct source identifier within the selected time, the commercials continue at step 255. If the user continuously clicks on the correct source identifiers, the user will complete the viewing cycle at step 260. At step 265, in certain embodiments, the user is asked for a first name and email to further the charitable purpose in the event that the marketer is a charity.

As set forth above, if the user does not select the correct source identifier or does not select any source identifier at all at step 235, the user is directed to the corresponding error page (1.html→1a.html, 2.html→2a.html, 3.html→3a.html, etc.) 240. An error page can occur at any point during the commercial sequence if the user does not solve the problem or answer the question or steps away from the user machine. Next at step 270, in certain embodiments, user is directed to error page/1a.html which continues to play the same commercial page/1a.html that the user did not choose the correct source identifier for the commercial page/1a.html playing at the time or did not make a choice at all until either the user either chooses the correct source identifier for the commercial page/1a.html at step 275 or quits the program at step 280.

The user may be directed to an error page at any time during the process if the correct source identifier is not chosen within the selected time frame. For example, if the user gets up to move away from his computer, the commercial page will redirect to an error page. However, when the user returns, selects the correct source identifier, the error page will be immediately redirected to the next commercial page in the series.

If the user selects the correct source identifier at error page/1a.html, 2a.html, 3a.html, 4a.html etc. 270, the commercial page/2.html, 3.html, 4.html, etc, completes at step 275 and the commercial page/2.html, 3.html, 4.html, etc, redirects automatically to commercial page/3., 3.html, 4.html, etc, html in step 285. In step 285, the user is again required to choose the source identifier from a multiple choice dialog box within a selected time period. If the user selects the correct source identifier within the selected time, the commercial pages/4.html, 5.html, 6.html. 7.html, etc. continue at step 290. If the user continuously clicks on the correct source identifiers, the user will complete the viewing cycle at step 260. If the user continuously clicks on the correct source identifiers, the user will complete the viewing cycle at step 260. At step 265, in certain embodiments, the user is asked for a first name and email to further the charitable purpose in the event that the marketer is a charity.

Funds are collected for each commercial viewed. For instance, if a user views the whole sequence funds are for that sequence are noted in the session data base. If only a portion of the sequence of the commercials is viewed, funds are noted in the database for the portion of commercials viewed.

In various embodiments, the problem comprises one or more commercials playing simultaneously and the user chooses from one or more source identifiers for each commercial playing simultaneously in order to move to the next commercials in sequence, wherein the finds are collected for each commercial playing simultaneously in which the correct source identifier is chosen.

In various embodiments, the problem comprises an image verification box that may or may not coincide with a commercial in the sequence, wherein if the correct image is typed into the user computer, the commercial sequence proceeds and funds are collected for each commercial played.

In various embodiments, the problem comprises an audio verification file that may or may not coincide with a commercial in the sequence, wherein if the correct message is typed into the user computer, the commercial sequence proceeds and funds are collected for each commercial played.

In various embodiments, the problem comprises a plurality of commercials in the sequence playing simultaneously along with a list of names of advertisers and in order to move to the next commercial sequence the users must match the names of the advertisers with the commercials, if the correct match is made, the funds are collected for each commercial viewed in the sequence and the commercial sequence proceeds until and/or unless an incorrect or no match is chosen.

In various embodiments, the commercial comprises a commercial in a puzzle form and the user must put together the pieces in order to proceed to next commercial in the sequence. In another embodiment, there may be a plurality of commercials in puzzle form wherein the user has to put together each commercial puzzle in order to proceed to the next commercial sequence.

In certain embodiments, when session is complete, session management database 180 is updated with all user IP session variables. An HTML form is used to collect email addresses.

Whereas FIG. 2 depicts a certain flow of events, the invention is not limited to these steps or this flow. Additional steps could be performed, steps could be left out, and the steps could be performed in parallel or in a different order. FIG. 2 is not limited by the problems listed in the application, as one of ordinary skill in the art would readily recognize, there are numerous types of problems that could substituted for the problems set forth in the present application. The problems set forth are for exemplary purposes only and are not intended to restrict the present invention.

### 4.0 HARDWARE OVERVIEW

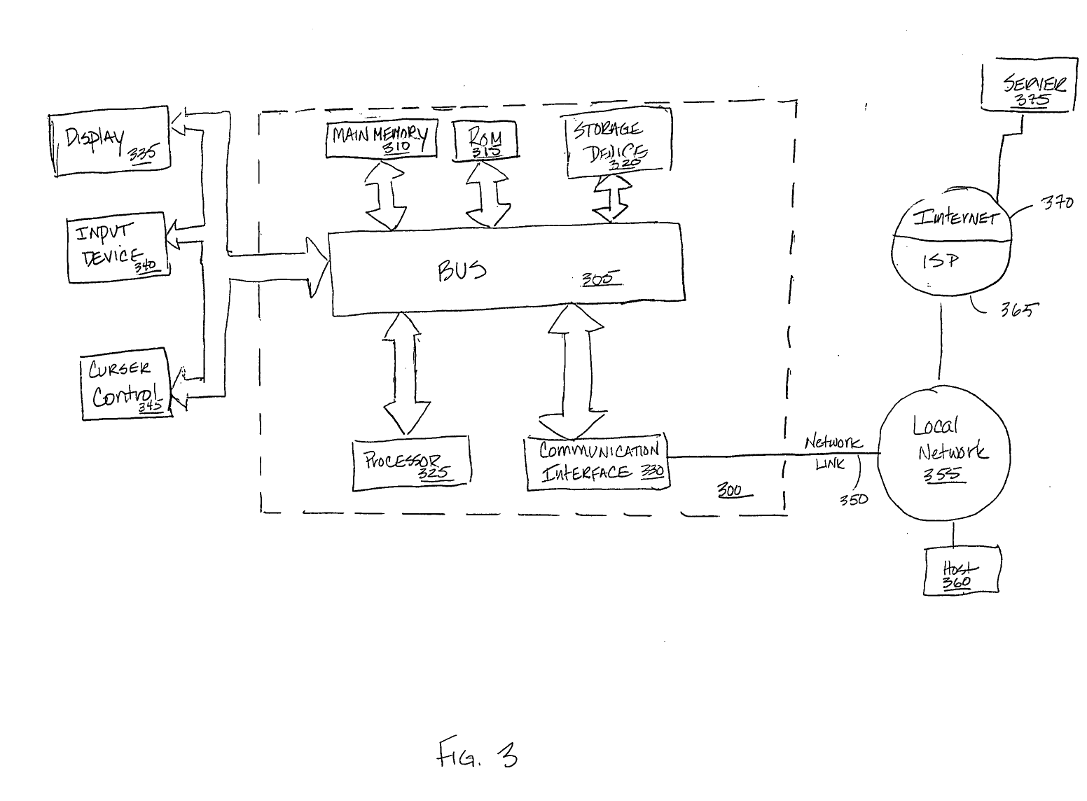

FIG. 3 is a block diagram that illustrates a computer system 300 upon which an embodiment of the invention may be implemented. Computer system 300 includes a bus 305 or other communication mechanism for communicating information, and a processor 325 coupled with bus 305 for processing information. Computer system 300 also includes a main memory 310, such as a random access memory (RAM) or other dynamic storage device, coupled to bus 305 for storing information and instructions to be executed by processor 325. Main memory 310 also may be used for storing temporary variables or other intermediate information during execution of instructions to be executed by processor 325. Computer system 300 further includes a read only memory (ROM) 315 or other static storage device coupled to bus 305 for storing static information and instructions for processor 304. A storage device 320, such as a magnetic disk or optical disk, is provided and coupled to bus 305 for storing information and instructions.

Computer system 300 may be coupled via bus 305 to a display 335, such as a cathode ray tube (CRT), for displaying information to a computer user. An input device 340, including alphanumeric and other keys, is coupled to bus 305 for communicating information and command selections to processor 325. Another type of user input device is cursor control 345, such as a mouse, a trackball, or cursor direction keys for communicating direction information and command selections to processor 304 and for controlling cursor movement on display 335. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 325 executing one or more sequences of one or more instructions contained in main memory 310. Such instructions may be read into main memory 310 from another machine-readable medium, such as storage device 320. Execution of the sequences of instructions contained in main memory 310 causes processor 325 to perform the process steps described herein. In alternative embodiments, hard-wired circuitry may be used in place of or in combination with software instructions to implement the invention. Thus, embodiments of the invention are not limited to any specific combination of hardware circuitry and software.

In an embodiment implemented using computer system 300, various machine-readable media are involved, for example, in providing instructions to processor 325 for execution. Such a medium may take many forms, including but not limited to, non-volatile media, volatile media, and transmission media. Non-volatile media includes, for example, optical or magnetic disks, such as storage device 320. Volatile media includes dynamic memory, such as main memory 310. Transmission media includes coaxial cables, copper wire and fiber optics, including the wires that comprise bus 305. Transmission media can also take the form of acoustic or light waves, such as those generated during radio-wave and infrared data communications. Various forms of machine-readable media may be involved in carrying one or more sequences of one or more instructions to processor 325 for execution.

Computer system 300 also includes a communication interface 330 coupled to bus 305. Communication interface 330 provides a two-way data communication coupling to a network link 350 that is connected to a local network 355. For example, communication interface 330 may be an integrated services digital network (ISDN) card or a modem to provide a data communication connection to a corresponding type of telephone line. As another example, communication interface 330 may be a local area network (LAN) card to provide a data communication connection to a compatible LAN. Wireless links may also be implemented. In any such implementation, communication interface 330 sends and receives electrical, electromagnetic or optical signals that carry digital data streams representing various types of information.

Network link 350 typically provides data communication through one or more networks to other data devices. For example, network link 350 may provide a connection through local network 355 to a host computer 360 or to data equipment operated by an Internet Service Provider 365. Internet Service Provider 365 in turn provides data communication services through the worldwide packet data communication network now commonly referred to as the Internet 370. Local network 355 and Internet 370 both use electrical, electromagnetic or optical signals that carry digital data streams. The signals through the various networks and the signals on network link 350 and through communication interface 330, which carry the digital data to and from computer system 300, are exemplary forms of carrier waves transporting the information.

Computer system 300 can send messages and receive data, including program code, through the network(s), network link 350 and communication interface 350. In the Internet example, a server 375 might transmit a requested code for an application program through Internet 370, ISP 365, local network 355 and communication interface 350.

The received code may be executed by processor 325 as it is received, and/or stored in storage device 320, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### 5.0 EXTENSIONS AND ALTERNATIVES

The foregoing invention is applicable to embodiments other than charitable donations including, but not limited to, school donations, and purchasing items, such as lottery tickets, mileage points, etc. The examples set forth are meant to clarify the invention and not to restrict the invention to these specific examples. As one of ordinary skill in the art would know, this invention could be applied in almost any area wherein money is aggregated for any purpose.

In the foregoing specification, the invention has been described with reference to specific embodiments thereof. It will, however, be evident that various modifications and changes may be made thereto without departing from the broader spirit and scope of the invention. The specification and the drawing are, accordingly, to be regarded in an illustrative rather than a restrictive sense.

1. A method of automated data collection and aggregation of monetary contributions comprising the steps of:
receiving data from a Web site having a marketing program uploaded from a provider server, comprising:
providing one or more Web sites displaying a series of commercials in sequence, wherein a user logs on to the Web site;
providing a problem having an answer combined with a commercial in the sequence, wherein if a correct answer to the problem is provided by the user, the commercial sequence proceeds and funds are collected for each commercial played in the sequence until and/or unless an incorrect or no answer is provided;
displaying an error page that replays the commercial at the point in the sequence where the user chose the incorrect answer until and/or if the correct answer is chosen;
ending the program if the correct answer is never chosen; and
continuing through the commercials in the sequence if the correct answer is continuously chosen and collecting funds until the user completes the sequence.

2. The method of claim 1, wherein one or more problems may be combined with one or more commercials in the sequence.

3. The method of claim 1, wherein the problem comprises an image verification box that may or may not coincide with a commercial in the sequence, wherein if the correct image is typed into the user computer, the commercial sequence proceeds and finds are collected for each commercial played.

4. The method of claim 1, wherein the problem comprises an audio verification file that may or may not coincide with a commercial in the sequence, wherein if the correct message is typed into the user computer, the commercial sequence proceeds and funds are collected for each commercial played.

5. The method of claim 1, wherein the problem comprises a plurality of commercials in the sequence playing simultaneously along with a list of names of advertisers and in order to move to the next commercial sequence the users must match the names of the advertisers with the commercials, if the correct match is made, the funds are collected for each commercial viewed in the sequence and the commercial sequence proceeds and funds are collected for each commercial played in the sequence.

6. The method of claim 1, wherein the problem comprises a plurality of source identifiers that coincide with a commercial in the sequence, wherein if the correct source identifier is chosen by the user, the commercial sequence proceeds and funds are collected for each commercial played in the sequence and funds are collected for each commercial played in the sequence.

7. The method of claim 1, wherein one or more error pages may be displayed until and/or if the answer is not chosen and wherein funds continue to be collected if the correct image is chosen.

8. The method of claim 1, wherein a command set comprises one or more commands to collect data from two or more devices simultaneously.

9. The method of claim 1, wherein receiving a request from a user to access an internet Web site further comprises tracking the user's internet protocol address and storing user's information in the provider data base and wherein the analysis results are based on user session variables.

10. A method of automated data collection and aggregation of monetary contributions comprising the steps of:
receiving data from a Web site having a marketing program uploaded from a provider server, comprising:
providing one or more Web sites displaying a series of commercials in sequence, wherein a user logs on to the Web site;
providing a plurality of source identifiers that coincide with a commercial in the sequence, wherein if the correct source identifier is chosen by the user, the commercial sequence proceeds and funds are collected for each commercial played in the sequence until and/or unless an incorrect or no source identifier is chosen;
displaying an error page that replays the commercial at the point in the sequence where the user chose the incorrect source identifier until and/or if the correct source identifier is chosen;
ending the program if the source identifier is never chosen; and
continuing through the commercials in the sequence if the correct source identifier is continuously chosen and collecting funds until the user completes the sequence.

11. The method of claim 10, wherein a command set comprises one or more commands to collect data from two or more devices simultaneously.

12. The method of claim 10, wherein one or more error pages may be displayed any time in the sequence until and/or if the correct source identifier is chosen, wherein funds continue to be collected if the correct source identifier is chosen.

13. The method of claim 10, wherein one or more commercials play simultaneously and the user chooses from one or more source identifiers for each commercial playing simultaneously in order to move to the next commercials in sequence, wherein the funds are collected for each commercial playing simultaneously in which the correct source identifier is chosen.

14. A method of automated data collection and marketing analysis from a user comprising the steps of:
receiving a request from a user machine to access an internet Web site, wherein the Web site displays a series of commercials in sequence;
providing a commercial in a puzzle form, wherein in order to move to the next commercial in the sequence, the user must arrange the puzzle in the correct order, wherein funds are collected for that commercial when the commercial is correctly arranged and the user moves to the next commercial in the sequence;
redirecting the user to an error page if the puzzle is arranged incorrectly, the error page replays the commercial at the sequence where the user arranged the puzzle incorrectly, until and/or if the puzzle is correctly arranged;
ending the program if the puzzle is not correctly arranged and/or;
continuing through the commercials in the sequence and collecting funds for each commercial when the user completes a sequence and/or a portion of the sequence; and
receiving and storing data from the user at a provider server.

15. The method of claim 14, wherein a command set comprises one or more commands to collect data from two or more devises simultaneously.

16. The method of claim 14, wherein receiving a request from a user to access an internet Web site further comprises tracking the user's internet protocol address and storing user's information in the provider data base and wherein the analysis results are based on user session variables.

17. The method of claim 14, wherein one or more commercials play simultaneously in puzzle form and the user must arrange each puzzle in the commercial sequence playing simultaneously in order to move to the next commercial sequence, wherein the funds are collected for each commercial playing simultaneously in which the commercial is arranged correctly.

18. The method of claim 14, wherein one or more error pages may be displayed any time in the sequence until and/or if the puzzle is arranged incorrectly and wherein funds continue to be collected if the puzzle is arranged correctly.

19. A method of capturing, analyzing marketing data and aggregating advertising funds comprising:
providing a provider server, wherein the server includes a session management data base, local/networked storage and an application download server;
downloading a marketing application to a network to gather specific session variables from user a machine by providing a commercial in a predetermined commercial sequence, wherein the user has to choose from a plurality of source identifiers before viewing and proceeding to the next commercial in the commercial sequence, wherein if the correct source identifier is chosen, funds are collected for each commercial viewed by the user;
gathering session variables using the session management database from user input; and
storing session variables in the local/networked storage.

20. The method of claim 19, wherein a command set comprises one or more commands to collect data from two or more devises simultaneously.

21. The method of claim 19, wherein specific session variables include IP addresses, visit time, number of commercials watched, number of times the user has visited the Web site, email addresses and other session variables.

22. An apparatus for capturing and analyzing marketing data and monetary contributions from a user comprising the steps of:
means for receiving data from one or more Web sites having a marketing program uploaded from a provider server, wherein receiving the data comprises:
providing one or more Web sites displaying a series of commercials in sequence, wherein a user logs on to the Web site;
providing a plurality of source identifiers that coincide with a commercial in the sequence, wherein if the correct source identifier is chosen by the user the commercial sequence proceeds and funds are collected for each commercial played in the sequence until and/or unless an incorrect or no source identifier is chosen;
displaying an error page that replays the commercial at the point in the sequence where the user chose the incorrect source identifier until and/or if the correct source identifier is chosen;
ending the program if the source identifier is never chosen; and
continuing through the commercials in the sequence if the correct source identifier is continuously chosen and collecting funds until the user completes the sequence.

23. The apparatus of claim 22, wherein a command set comprises one or more commands to collect data from two or more devices simultaneously.

24. The apparatus of claim 22, wherein one or more commercials play simultaneously and the user chooses from one or more source identifiers for each commercial playing simultaneously in order to move to the next commercial sequence, wherein the funds are collected for each commercial playing simultaneously in which the correct source identifier is chosen.

25. The apparatus of claim 22, wherein specific session variables include IP addresses, visit time, number of commercials watched, number of times the user has visited the Web site, email addresses and other session variables.

26. The apparatus of claim 22, wherein one or more error pages may be displayed any time in the sequence until and/or if the correct source identifier is chosen, wherein funds continue to be collected if the correct source identifier is chosen.

27. An apparatus for capturing and analyzing marketing data comprising:
monetary contributions from a user comprising the steps of:
means for receiving data from one or more Web sites having a marketing program uploaded from a provider server, wherein receiving the data comprises:
providing one or more Web sites displaying a series of commercials in sequence, wherein a user logs on to the Web site;
providing a commercial in a puzzle form, wherein in order to move to the next commercial in the sequence, the user must arrange the puzzle in the correct order, wherein the funds are collected for that commercial when the commercial is correctly arranged and the user moves to the next commercial in the sequence;
displaying an error page that replays the commercial at the point in the sequence where the user chose puzzle piece until and/or if the puzzle piece is chosen, wherein if the correct puzzle piece is chosen the sequence proceeds and funds continue to be collected;
ending the program if the source identifier is never chosen; and
continuing through the commercials in the sequence if the correct source identifier is continuously chosen and collecting funds until the user completes the sequence.
